(19) United States
(12) Patent Application Publication
(10) Pub. No.: US 2011/0007843 A1
(43) Pub. Date: Jan. 13, 2011

(54) LOW POWER FM TRANSMITTER

(75) Inventors: Shahla Khorram, IRVINE, CA (US); Frank (Bo-Shiou) Ke, IRVINE, CA (US); Amir Ibrahim, NEWPORT BEACH, CA (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/498,421

(22) Filed: Jul. 7, 2009

(51) Int. Cl. H04L 27/12

(52) U.S. Cl. 375/302; 455/110

(57) ABSTRACT

An FM transmitter operates at low power by maintaining a substantially constant transmit voltage over the FM frequency band. A transmit signal strength indicator (TSSI) is provided at the output of the FM transmitter to measure the power at the output of the power amplifier. The TSSI generates a power control signal indicative of the output power and inputs the power control signal to the baseband processor. The baseband processor generates gain control signals to control the gain of various analog stages of the FM transmitter based on the power control signal.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention is related generally to frequency modulated (FM) systems, and more particularly to FM transmitter architectures.

2. Description of Related Art

Conventional broadcast radio stations operate on fixed radio frequency (RF) channels. In the U.S., these channels are regulated and licensed for specific purposes by the Federal Communications Commission (FCC). For example, the frequency band from 535 kilohertz (kHz) to 1.7 megahertz (MHz) is designated for AM broadcast radio, while the frequency band from 88 MHz to 108 MHz is designated for FM broadcast radio. Within any particular region of the U.S., there may be one or more radio stations broadcasting within the FM frequency band. The FCC designates a particular FM radio channel to each radio station, so that no two radio stations are broadcasting on the same radio channel within the same region.

To tune a radio device to a particular broadcasting radio station, either a user can select the desired radio channel on the radio device or the radio device can scan through the FM frequency band until the desired radio channel is reached. Outside of the broadcast spectrum, FM frequency scanners are often used within two-way radio devices or FM transmitters to search for a channel with a valid transmission. To avoid interference with nearby FM radio stations, the radio devices communicate on FM radio channels that are inactive in the region that the radio devices are located. That is, the radio devices communicate using FM radio channels that are not allocated to any radio station within the area and on which no signal is currently present.

Once communication between the radio devices is established over an inactive FM radio channel, the radio devices may communicate audio data (e.g., speech or music) and/or digital data, such as numeric messages and/or text messages, over the FM radio channel. In addition, the radio devices may employ modulation schemes, such as frequency shift keying, audio frequency shift keying or quadrature shift keying to encode the data. Therefore, each radio device typically includes a built-in transceiver (transmitter and receiver) for modulating/demodulating information (data or speech) bits into a format that comports with a particular communication standard utilized by the radio devices.

However, FM transceivers typically include the traditional 50 ohm antenna found in cellular phone devices, which requires FM transceivers to be operated at high power. As a result, FM transceivers often suffer from a shortened battery life. To increase the battery life, a more expensive battery may be used. However, this also increases the cost of the FM transceiver.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram illustrating a communication system that includes FM radio devices capable of communicating with each other using frequencies within the FM radio spectrum in accordance with the present invention;

FIG. 2 is a schematic block diagram illustrating a wireless device that includes a host device and an associated FM radio in accordance with the present invention;

FIG. 3 is a schematic block diagram illustrating an FM radio transmitter in accordance with the present invention;

FIG. 4 is a schematic block diagram illustrating a more detailed view of the FM radio transmitter in accordance with the present invention;

FIG. 5 is a schematic block diagram illustrating a more detailed view of the power amplifier of the FM radio transmitter in accordance with the present invention; and

FIG. 6 is a logic diagram of a method for operating an FM transmitter in accordance with the present invention.

### DETAILED DESCRIPTION OF THE INVENTION

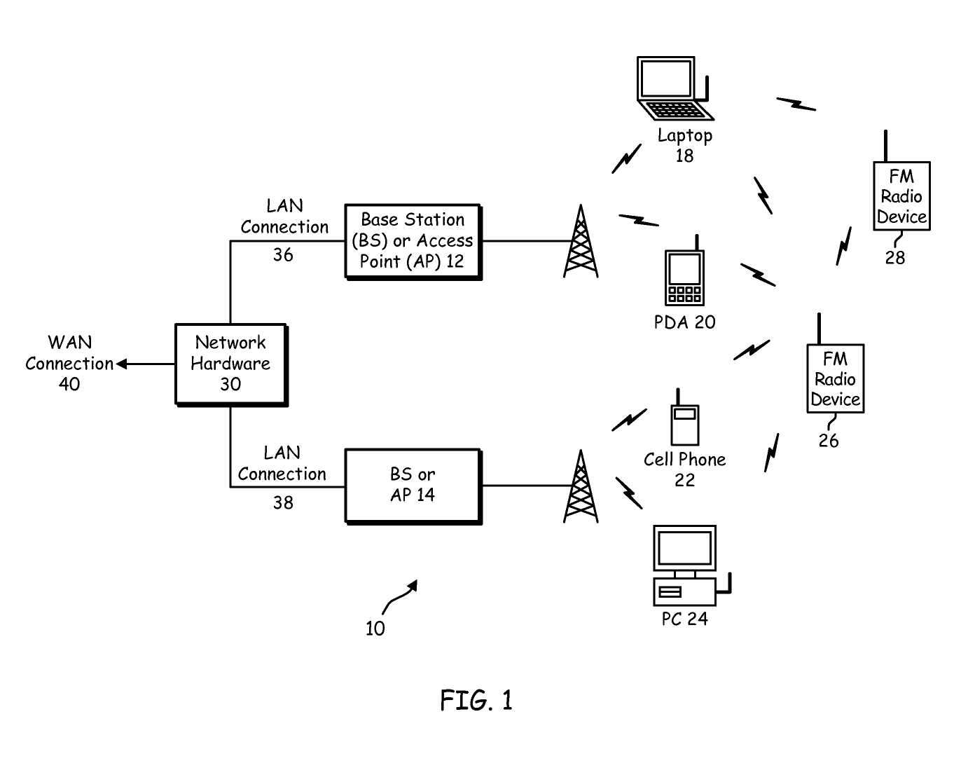

FIG. 1 is a functional block diagram illustrating an exemplary wireless system 10 for use in embodiments of the present invention. The wireless system shown in FIG. 1 includes a plurality of wireless devices 18-28. For example, the wireless devices may be radio devices, such as FM radio devices 26 and 28, or communication devices, such as laptop computer 18, personal digital assistant 20, cellular telephone 22 and/or personal computer 24. FM radio devices 26 and 28 may be car radios, portable radios, personal A/V players, such as MP3 players, and/or other wireless devices that include FM radio devices.

Currently, there is a trend towards enabling cellular telephone 22 and other wireless devices, such as laptop computers 18, PDAs 20, personal computers 24 and other devices 26 and 28 (e.g., MP3 players, portable radios, etc.), to provide FM transmission and/or reception. Therefore, in FIG. 1, each of the wireless devices 18-28 includes an FM transmitter operable to transmit a frequency modulated (FM) signal within the FM frequency band on one or more FM radio frequencies. In addition, each of the wireless devices 18-28 may further include an FM receiver operable to receive an FM signal within the FM frequency band on one or more FM radio frequencies. As used herein, the term “FM frequency band” includes frequencies between 65 MegaHertz (MHz) and 108 MHz.

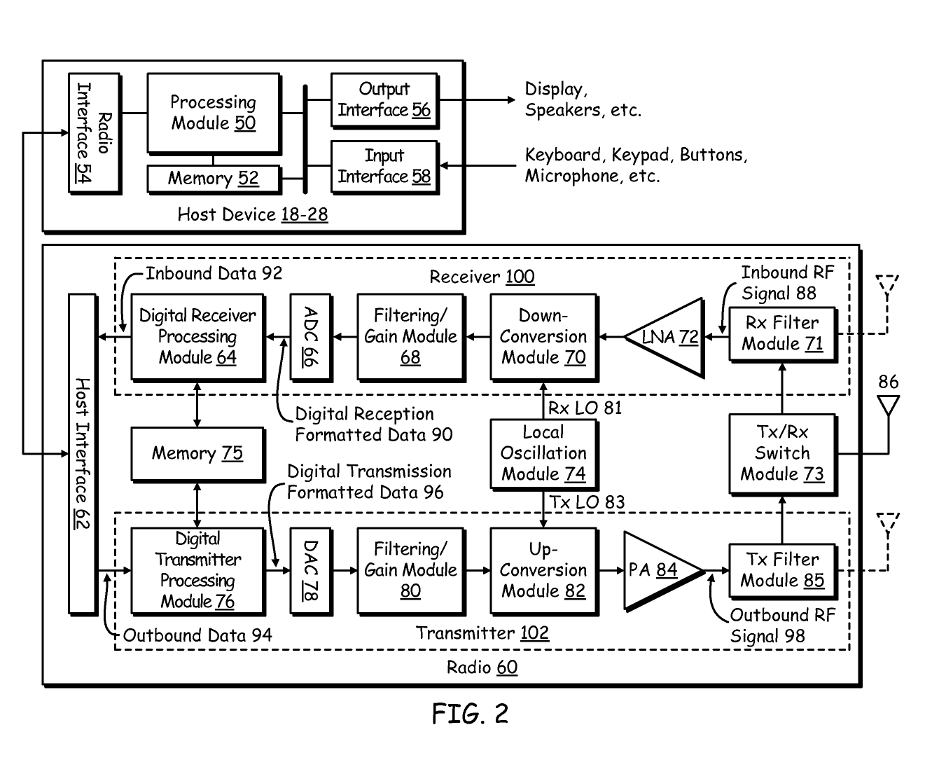

Furthermore, each of the communication devices 18-24 includes a transceiver (transmitter and receiver) for communicating with a base station or access point 12-14 of a wireless communication network. In one embodiment, the communication devices 18-24 include separate transceivers for FM and cellular communications. In another embodiment, the communication devices 18-24 include a single transceiver capable of supporting both FM and cellular operations. The details of the wireless devices 18-28 will be described in greater detail with reference to FIG. 2.

Typically, base stations are used for cellular telephone networks and like-type networks, while access points are used for in-home or in-building wireless networks. For example, access points are typically used in Bluetooth systems. Regardless of the particular type of wireless communication network, the communication devices 18-24 and the base station or access point 12-14 each include a built-in transceiver (transmitter and receiver) for modulating/demodulating information (data or speech) bits into a format that comports with the type of wireless communication network. There are a number of well-defined wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof) that could facilitate such wireless communication between the communication devices 18-24 and a wireless communication network.

The base stations or access points 12-14 are coupled to a network hardware component 30 via local area network (LAN) connections 36 and 38. The network hardware component 34, which may be a router, switch, bridge, modem, system controller, etc., provides a wide area network (WAN) connection 40 for the wireless communication network. Each of the base stations or access points 12-14 has an associated antenna or antenna array to communicate with the wireless communication devices in its area. Typically, the wireless communication devices 18-24 register with the particular base station or access points 12 or 14 to receive services from the wireless network. For direct connections (i.e., point-to-point communications), wireless communication devices communicate directly via an allocated channel. Although a network topology is shown in FIG. 1, it should be understood that the present invention is not limited to network topologies, and may be used in other environments, such as peer-to-peer, access point or mesh environments.

In the U.S., FM radio stations are allocated respective FM channels, each containing 200 kHz of bandwidth around the carrier frequency (in Europe, it is 100 kHz). To avoid interference with nearby FM radio stations, the wireless devices 18-28 communicate on FM radio channels that are inactive in the region that the wireless devices 18-28 are located. That is, the wireless devices 18-28 communicate using FM radio channels that are not allocated to any radio station within the area and on which no signal is currently present.

In one embodiment, the wireless devices 18-28 are able to analyze the FM frequency band to identify the inactive FM radio channels therein and to select one of the inactive FM radio channels on which to establish communication with each other. For example, one or more of the wireless devices 18-28 may include a scanner capable of scanning the FM frequency band to identify the inactive FM radio channels. In addition, one or more of the wireless devices 18-28 may further be able to measure the interference on one or more of the inactive FM radio channels and to select the inactive FM radio channel on which to initiate communication based on the measured interferences. As a result, the wireless devices 18-28 can communicate on an inactive FM radio channel that has an acceptable level of interference.

In another embodiment, the wireless devices 18-28 have access to FM radio station information identifying the frequency bands that are allocated to FM radio stations within the geographical area that the wireless devices 18-28 are currently located, and the wireless devices 18-28 are able to select an FM radio channel that is not allocated to any FM radio station to communicate with each other. For example, the FM radio station information may be stored within the wireless devices 18-28 or downloaded to the wireless devices 18-28 via, for example, the network hardware 30. If the FM radio station information is stored within the wireless devices 18-28, the wireless devices 18-28 may further be able to determine their current geographical location using any available locating technique, such as the Global Positioning System (GPS) or a network-based locating technique.

In an exemplary operation, a user of a particular wireless device 18-28 instructs the wireless device 18-28 to initiate communication with another wireless device 18-28 over an FM channel. For example, a user may desire to interconnect their cell phone 22 to a car audio system 26 to communicate navigation data or other data to the car audio system 26. As another example, as user may desire to interconnect their MP3 player 28 to the car audio system 26 to play music stored on the MP3 player 28 through the car audio system 26.

In one embodiment, to establish the communication between two FM wireless devices (e.g., radio devices 26 and 28), a user of one of the radio devices (e.g., radio device 26) is apprised of the selected FM channel by the other radio device 28 and is directed to tune the radio device 26 to the selected FM channel. For example, a user may receive a text message or other message on yet another wireless device (e.g., cell phone 22) that instructs that user to tune his/her radio device 26 to a particular FM channel. As another example, one of the wireless devices 26 may be a car audio system within an automobile and the other wireless device 22 may be a cell phone within the automobile. The cell phone 22 may display a message to the user instructing the user to tune the car audio system 26 to a particular inactive FM radio channel in order for the cell phone 22 to communicate music and/or data to the car audio system 26.

In another embodiment, one of the wireless devices (e.g., radio device 28) may select the inactive FM radio channel and communicate the identity of the selected inactive FM radio channel to another wireless device (e.g., laptop 18) over a dedicated control channel, which may one of one or more predetermined FM radio channels. As an example, there may be several FM radio channels that are known to not be allocated in certain geographical areas (e.g., a state within the U.S.) or who are known to not be allocated across the majority of a particular geographical area (e.g., the U.S.), and one or more of these may be designated as potential control channels for the wireless devices 18 and 28.

Once communication between the wireless devices is established over an inactive FM radio channel, the wireless devices may communicate audio data (e.g., speech and/or music) and/or digital data, such as numeric messages and/or text messages, over the FM radio channel. In addition, the wireless devices 18-28 may employ modulation schemes, such as frequency shift keying, audio frequency shift keying or quadrature shift keying to encode the data transmitted via the selected inactive FM channel. For example, if a received FM radio signal includes digital data, the wireless device 18-28 receiving the FM radio signal can demodulate the digital data, and then display the digital data on a display of the wireless device 18-28.

As an example, if a car audio system 28 is currently tuned to an inactive FM radio channel containing digital data identifying the status of traffic within the geographical area, the display on the car audio system 28 can display the current traffic status on a display of the car audio system 28. To prevent unauthorized listeners from tuning to the same FM radio channel and “listening in”, the audio and/or digital data can be encrypted to protect the confidentiality of the data and to verify the integrity and authenticity of the data.

In a further embodiment, the wireless devices 18-28 may utilize an embedding technique to embed digital data within an audio signal that is transmitted over the FM radio channel. For example, the wireless devices 18-28 may use a technique similar to the Radio Data System (RDS). RDS is a separate radio signal (subcarrier) that fits within the station's frequency allocation. The RDS subcarrier carries digital information at a frequency of 57 kHz with a data rate of 1187.5 bits per second. The RDS data is transmitted simultaneously with the standard audio signal. More specifically, the RDS operates by adding data to the baseband signal that is used to modulate the radio frequency carrier. The RDS data is placed above the audio signal on a 57 kHz RDS subcarrier that is locked onto the pilot tone. The RDS subcarrier is phase modulated, typically using a form of modulation called Quadrature Phase Shift Keying (QPSK). By phase modulating the RDS data and operating the RDS subcarrier at a harmonic of the pilot tone, potential interference with the audio signal is reduced.

FIG. 2 is a schematic block diagram illustrating a wireless device that includes the host device 18-28 and an associated FM radio 60. For cellular telephone hosts and radio hosts, the radio 60 is a built-in component. For personal digital assistants hosts, laptop hosts, and/or personal computer hosts, the radio 60 may be built-in or an externally coupled component.

As illustrated, the host device 18-28 includes a processing module 50, memory 52, a radio interface 54, an input interface 58 and an output interface 56. The processing module 50 and memory 52 execute the corresponding instructions that are typically done by the host device 18-28. For example, for a cellular telephone host device, the processing module 50 performs the corresponding communication functions in accordance with a particular cellular telephone standard.

The radio interface 54 allows data to be received from and/or sent to the radio 60. For data received from the radio 60 (e.g., inbound data), the radio interface 54 provides the data to the processing module 50 for further processing and/or routing to the output interface 56. The output interface 56 provides connectivity to an output device such as a display, monitor, speakers, etc., such that the received data may be displayed. The radio interface 54 also provides data from the processing module 50 to the radio 60. The processing module 50 may receive the outbound data from an input device, such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a transmitter 102, a memory 75, a local oscillation module 74, and in embodiments in which the radio 60 is a transceiver, a receiver 100 and an optional transmitter/receiver (Tx/Rx) switch module 73. The radio 60 further includes an antenna 86. In the transceiver shown in FIG. 2, the antenna 86 is shared by the transmit and receive paths as regulated by the Tx/Rx switch module 73. However, in other embodiments, the transmit and receive paths may use separate antennas. In addition, in embodiments in which the host device 18-28 is a communication device, such as a cell phone, laptop computer, personal computer or PDA, the radio 60 and antenna 86 may be shared between cellular and FM applications. For example, the local oscillation module 74 may be configured to provide an appropriate local oscillation signal for up-converting and down-converting both FM and cellular frequencies, depending on the mode of operation (FM or cellular). In other embodiments, a separate antenna 86 and/or radio 60 may be provided for cellular and FM applications.

As shown in FIG. 2, the receiver 100 includes a digital receiver processing module 64, an analog-to-digital converter 66, a filtering/gain module 68, a down-conversion module 70, a low noise amplifier 72 and a receiver filter module 71. The transmitter 102 includes a digital transmitter processing module 76, a digital-to-analog converter 78, a filtering/gain module 80, an IF mixing up-conversion module 82, a power amplifier 84 and a transmitter filter module 85.

The digital receiver processing module 64 and the digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and/or modulation. The digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the digital receiver processing module 64 and/or the digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and the digital receiver processing module 64 and/or the digital transmitter processing module 76 executes, operational instructions corresponding to at least some of the functions illustrated herein.

In an exemplary operation of the receiver 100, when the radio 60 receives an inbound frequency modulated (FM) signal 88 having a particular bandwidth and carrier frequency tuned to by the antenna 86, which was transmitted by another wireless device, the antenna 86 provides the inbound RF signal 88 to the receiver filter module 71 via the Tx/Rx switch module 73. The Rx filter module 71 bandpass filters the inbound RF signal 88 and provides the filtered RF signal to low noise amplifier 72, which amplifies the inbound RF signal 88 to produce an amplified inbound RF signal. The low noise amplifier 72 provides the amplified inbound RF signal to the down-conversion module 70, which directly converts the amplified inbound RF signal into an inbound low IF signal (e.g., at 200 kHz IF) based on a receiver local oscillation 81 provided by local oscillation module 74. The down-conversion module 70 provides the inbound low IF signal to the filtering/gain module 68.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92. The host interface 62 provides the recaptured inbound data 92 to the host device 18-32 via the radio interface 54.

In an exemplary operation of the transmitter 102, when the radio 60 receives outbound data 94 from the host device 18-28 via the host interface 62, the host interface 62 routes the outbound data 94 to the digital transmitter processing module 76. The digital transmitter processing module 76 processes the outbound data 94 in accordance with a particular wireless communication standard (e.g., IEEE 802.11a, IEEE 802.11b, Bluetooth, etc.), if necessary, to produce digital transmission formatted data 96. The digital-to-analog converter 78 converts the digital transmission formatted data 96 from the digital domain to the analog domain. The filtering/gain module 80 filters and/or adjusts the gain of the analog low IF signal prior to providing it to the up-conversion module 82. The up-conversion module 82 directly converts the analog low IF signal into an RF signal based on a transmitter local oscillation 83 provided by local oscillation module 74. The power amplifier 84 amplifies the RF signal to produce an outbound RF signal 98, which is filtered by the transmitter filter module 85. The antenna 86 transmits the outbound RF signal 98 to a targeted device, such as a another wireless device.

As one of average skill in the art will appreciate, the wireless device of FIG. 2 may be implemented using one or more integrated circuits. For example, the host device 18-28 may be implemented on a first integrated circuit, while the digital receiver processing module 64, memory 75 and/or the digital transmitter processing module 76 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device 18-28 and the digital receiver processing module 64 and/or the digital transmitter processing module 76 may be a common processing device implemented on a single integrated circuit. Further, memory 52 and memory 75 may be implemented on a single integrated circuit and/or on the same integrated circuit as the common processing modules of processing module 50, the digital receiver processing module 64, and/or the digital transmitter processing module 76.

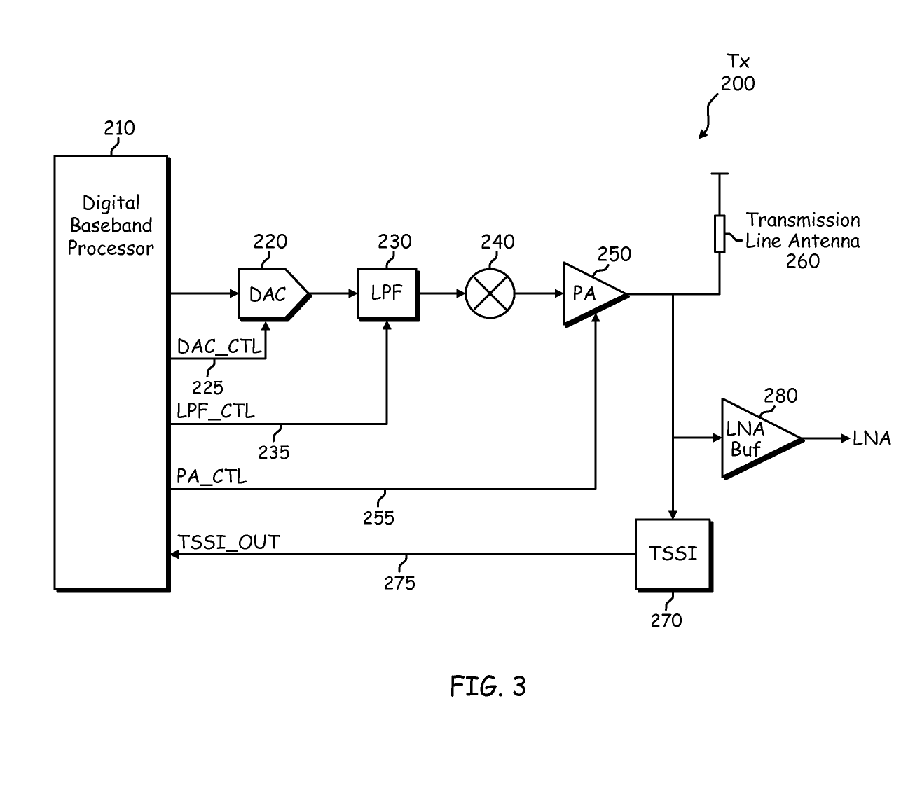

FIG. 3 is a schematic block diagram illustrating an FM radio transmitter 200 in accordance with the present invention. The FM radio transmitter 200 corresponds, at least in part, to the transmitter 102 shown in FIG. 2. The FM radio transmitter in FIG. 3 includes a digital baseband processor 210, digital-to-analog converter (DAC) 220, low pass filter (LPF) 230, mixer 240, power amplifier (PA) 250 and transmission line (loop) antenna 260, which correspond, at least in part, to the functionality of blocks 76-86 of FIG. 2.

As described above, in an exemplary operation, the DAC 220 is coupled to receive complex modulated digital signal from the digital baseband processor 210 and operates to convert the complex modulated digital signal to a complex modulated analog signal. The LPF 230 is coupled to receive the complex modulated analog signal and operates to filter the complex modulated analog signal to produce a filtered complex modulated analog signal. The mixer 240 is coupled to receive the filtered complex modulated analog signal and operates to up-convert the filtered complex modulated analog signal from a baseband or intermediate frequency (e.g., 200 kHz) to an RF frequency within the FM frequency band to produce a modulated RF signal. The modulated RF signal is input to PA 250, where it is amplified and coupled to the loop antenna 260.

In accordance with embodiments of the present invention, each of the gain stages FM transmitter 200 (e.g., the DAC 220, LPF 230, mixer 240 and PA 250) are substantially linear in order to minimize out of band spurious transmissions. In addition, the DAC 220, LPF 230 and mixer 240 are designed to operate at less than 2.5 mA (milliamperes) and the PA 250 is designed to operate between 200 μA (microamperes) and 3 mA to deliver 117 dB to the loop antenna 260. Therefore, the FM transmitter 200 is able to operate at low power.

In order to achieve the low power operation of the FM transmitter 200, a constant transmit voltage over the FM frequency band is maintained, as described below. By maintaining a constant transmit voltage, a high Q, high impedance antenna 260 (e.g., greater than 2 kΩ with a Q of 30 in the FM frequency band) may be used. As such, the FM transmitter 200 can be operated at a much lower power than when a traditional 50Ω antenna is used.

To maintain a constant transmit voltage, in one embodiment, the FM radio transmitter in FIG. 3 includes a transmitter signal strength indicator (TSSI) 270 coupled to the output of the PA 250. The TSSI 270 measures the output power at the output of the PA 250 and generates a power control signal (TSSI_Out) 275 indicative of the output power. For example, the TSSI 275 can be operable to generate a voltage proportional to the output power. In another embodiment, if the FM transmitter is part of a transceiver, the output of the PA 250 may be coupled to an optional low noise amplifier (LNA) buffer 280, which is coupled to a LNA within a receiver, such as the receiver shown in FIG. 2. In this embodiment, the receiver can measure the output power and produce the power control signal 275. In either embodiment, the power control signal 275 is input to the digital baseband processor 210, which uses the power control signal 275 to generate gain control signal(s) 225, 235 and 275 to control the gains of the DAC 220, LPF 230 and PA 250, respectively, in order to maintain a constant transmit voltage.

For example, the digital baseband processor 210 can compare the measured output power of the PA 250 to a desired output power to determine a power offset therebetween. The digital baseband processor 210 can then calculate the respective gains of the DAC 220, LPF 230 and PA 250 that are needed in order to minimize the power offset, and therefore, bring the measured output power substantially equal to the desired output power. Once the gains have been calculated, the digital baseband processor can generate and transmit a gain control signal (DAC_CTL) 225 to the DAC 220 to set the gain of the DAC 220, a gain control signal (LPF_CTL) 235 to the LPF 230 to set the gain of the LPF 230 and a gain control signal (PA_CTL) 255 to the PA 250 to set the gain of the PA 250. In an exemplary embodiment, the PA 250 is a two-stage PA that includes four 6 dB gain steps and six 1 dB gain steps, which can all be set using the gain control signal (PA_CTL) 255.

This process can be repeated recursively until the power offset between the measured and desired output power is sufficiently minimized or eliminated. In an exemplary embodiment, this process is performed during an off-line calibration operation of the FM transmitter 200 and/or during a real-time, on-line, change channel operation of the FM transmitter 200.

In addition, since the loop antenna 260 is a high Q, high impedance antenna 260, the PA 250 drives the loop antenna 260 with a high Q, high impedance inductor. For example, in an exemplary embodiment, the PA 250 drives the loop antenna 260 with an inductance of at least 120 nanohenry. Moreover, in an exemplary embodiment, the PA 250 operates to produce an amplitude voltage of over 1 volt and a peak-to-peak voltage of over 2 volts across the loop antenna 260. Therefore, the output of the PA 250 should be properly tuned in order to provide the necessary impedance and voltage. As a result, the digital baseband processor 210 can further generate and transmit a tune control signal, along with the gain control signal 255, to tune the output of the PA 250. The tune control signal 255 can also be generated by the digital baseband processor 210 based on the power control signal 275.

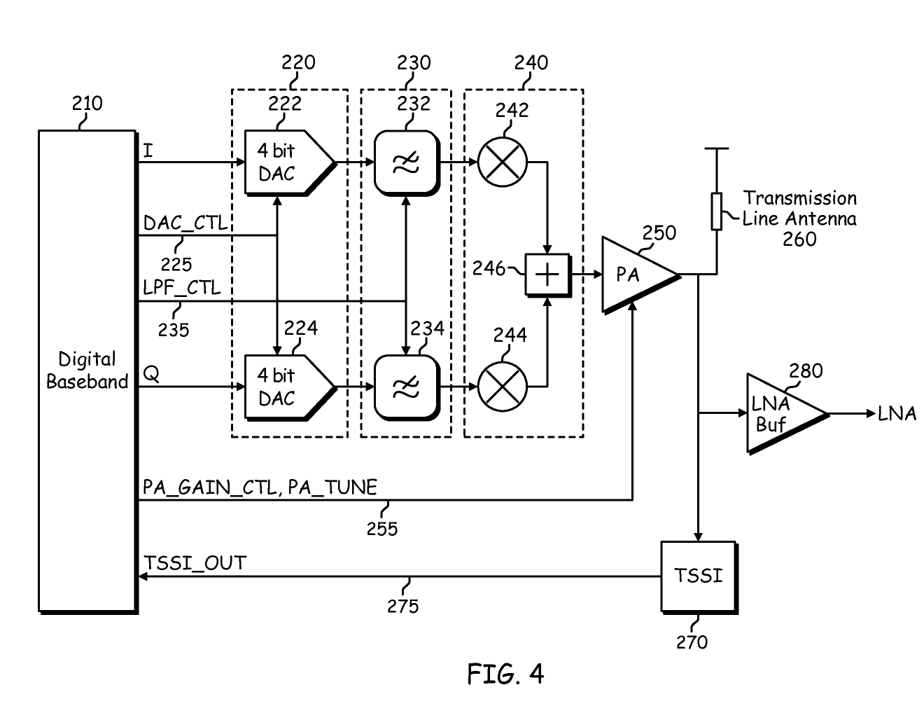

FIG. 4 is a schematic block diagram illustrating a more detailed view of the FM radio transmitter 200 in accordance with the present invention. FIG. 4 illustrates how the separate components of the complex modulated digital signal output by the digital baseband processor 210 are handled. Thus, FIG. 4 specifically illustrates an in-phase component (I) and a quadrature component (Q) of the complex modulated digital signal.

As such, the DAC 220 in FIG. 4 includes two 4-bit DAC's 222 and 224, each coupled to receive a respective one of the I/Q digital signals and operate to convert the I/Q digital signals to I/Q analog signals. In addition, the LPF 230 includes two LPF's 232 and 234, each coupled to receive a respective one of the I/Q analog signals and operate to filter the I/Q analog signals to produce filtered I/Q analog signals. Furthermore, the mixer 240 includes two mixers 242 and 244 and a summation node 246. Mixer 242 is coupled to receive the filtered in-phase analog signal from LPF 232, while mixer 244 is coupled to receive the filtered quadrature analog signal from LPF 234. Mixers 242 and 244 operate to up-convert the I/Q signals from a baseband or intermediate frequency (e.g., 200 kHz) to an RF frequency within the FM frequency band. The summation node 246 combines the I/Q RF signals to produce a modulated RF signal that is input to PA 250. For example, in an exemplary embodiment, the DACs 222 and 224 operate to generate respective currents that are mirrored to the LPF's 232 and 234 and mixers 242 and 244. The mixers 242 and 244 operate to up-convert the received currents to an FM frequency and mirror the current to the PA 250.

As in FIG. 3, the output of the PA 250 is input to the TSSI 270 or the optional LNA buffer 280 to measure the output power and generate the power control signal 275 that is sent to the digital baseband processor 210. The digital baseband processor 210 uses the power control signal 275 to generate gain control signal(s) 225, 235 and 275 to control the gains of the DAC 220, LPF 230 and PA 250, respectively, in order to maintain a constant transmit voltage. For example, the digital baseband processor 210 can generate and transmit a respective gain control signal (DAC_CTL) 225 to each of the DACs 222 and 224 to set the respective gains of the DACs 222 and 224, a respective gain control signal (LPF_CTL) 235 to each of the LPF 232 and 234 to set the respective gains of the LPFs 232 and 234 and a gain control signal (PA_CTL) and tune control signal (PA_TUNE) 255 to the PA 250 to set the gain and tune the output of the PA 250.

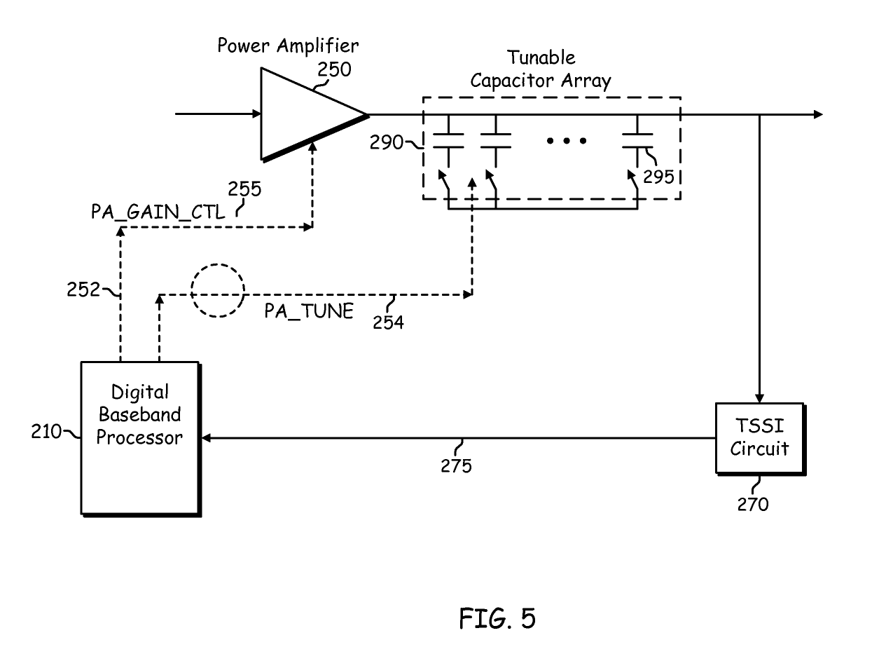

FIG. 5 is a schematic block diagram illustrating a more detailed view of the power amplifier (PA) 250 of the FM radio transmitter in accordance with the present invention. As described above, the output of the PA 250 should be tuned in order to provide the proper impedance and voltage to the antenna. Therefore, the PA 250 includes an array of tunable capacitors 290 at the output. In an exemplary embodiment, the array 290 includes a plurality of 8-bit switched capacitors 295 to produce a high Q, high impedance output of the PA 250.

As in FIGS. 3 and 4, the output of the PA 250 is input to the TSSI circuit 270, which generates a power control signal 275 to the digital baseband processor 210 indicative of the output power of the PA 250. The digital baseband processor 210 then calculates a gain of the PA 250 that is needed to bring the output power of the PA 250 substantially equal to a desired output power and transmits a gain control signal (PA_GAIN_CTL) 252 to the PA 250 to set the gain of the PA 250 in accordance with the calculated gain. In addition, the digital baseband processor 210 calculates a capacitance needed to produce the necessary high Q, high impedance output of the PA 250 and transmits a tune control signal (PA_TUNE) 254 to the capacitor array to switch in/switch out capacitors 295 within the array 290 to produce the calculated capacitance, thereby tuning the PA output appropriately. The gain control signal (PA_GAIN_CTL) 252 and tune control signal (PA_TUNE) 254 collectively form the PA control signal 255 shown in FIGS. 3 and 4.

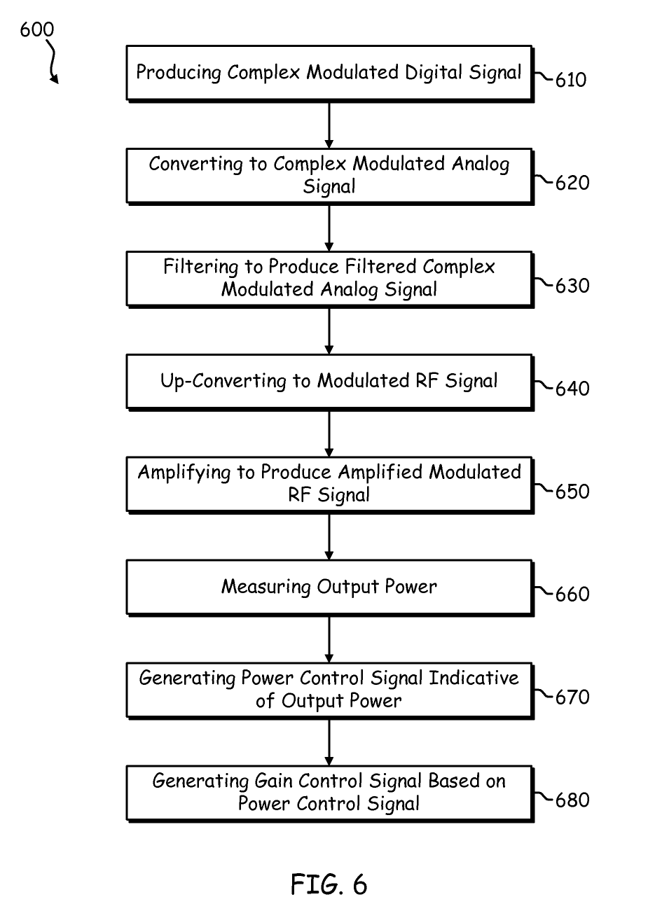

FIG. 6 is a logic diagram of a method 600 for operating an FM transmitter in accordance with the present invention. The method begins at step 610, where a complex modulated digital signal is produced. At step 620, the complex modulated digital signal is converted from digital to analog to produce a complex modulated analog signal. At step 630, the complex modulated analog signal is low pass filtered to produce a filtered complex modulated analog signal. Thereafter, at step 640, the filtered complex modulated analog signal is up-converted from a baseband or intermediate frequency to a radio frequency (RF) within an FM frequency band to produce a modulated RF signal, and at step 650, the modulated RF signal is amplified to produce an amplified modulated RF signal.

The output power of the amplified modulated RF signal is measured at step 660, and at step 670, a power control signal indicative of the output power is generated. From the power control signal, at step 680, one or more gain control signals are generated to control the gain of various stages of the FM transmitter in order to maintain a substantially constant transmit voltage over the FM frequency band.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has further been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The preceding discussion has presented an FM transmitter and method of operation thereof. As one of ordinary skill in the art will appreciate, other embodiments may be derived from the teaching of the present invention without deviating from the scope of the claims.

What is claimed is:

1. A frequency modulated (FM) transmitter, comprising:
a baseband processor operable to produce a complex modulated digital signal;
a Digital-to-Analog Converter (DAC) coupled to receive the complex modulated digital signal and operable to convert the complex modulated digital signal to a complex modulated analog signal;
a low pass filter coupled to receive the complex modulated analog signal and operable to produce a filtered complex modulated analog signal;
a mixer coupled to receive the filtered complex modulated analog signal and operable to up-convert the filtered complex modulated analog signal to a modulated RF signal;
a power amplifier coupled to receive the modulated RF signal and operable to produce an amplified modulated RF signal; and
a transmit signal strength indicator (TSSI) coupled to receive the modulated RF signal and operable to measure the output power of the modulated RF signal, the TSSI being further operable to generate a power control signal indicative of the output power of the modulated RF signal and to provide the power control signal to the baseband processor;
wherein the baseband processor is further operable to generate a gain control signal based on the power control signal to control a respective gain of the DAC, low pass filter and power amplifier to maintain a substantially constant transmit voltage over an FM frequency band.

2. The FM transmitter of claim 1, wherein the complex modulated digital signal includes an in-phase modulated digital signal and a quadrature modulated digital signal.

3. The FM transmitter of claim 2, wherein the Digital-to-Analog converter includes first and second Digital-to-Analog converters for converting the in-phase modulated digital signal and the quadrature modulated digital signal, respectively, from analog to digital to produce an in-phase modulated analog signal and a quadrature modulated analog signal, respectively.

4. The FM transmitter of claim 3, wherein the low pass filter includes first and second low pass filters for filtering the in-phase modulated analog signal and the quadrature modulated analog signal, respectively, to produce a filtered in-phase modulated analog signal and a filtered quadrature modulated analog signal, respectively.

5. The FM transmitter of claim 4, wherein the mixer includes first and second mixers for up-converting the filtered in-phase modulated analog signal and the filtered quadrature modulated analog signal, respectively, to produce an in-phase modulated RF signal and a quadrature modulated RF signal, respectively, and further comprising:
a summation node coupled to receive the in-phase modulated RF signal and the quadrature modulated RF signal and operable to produce the modulated RF signal.

6. The FM transmitter of claim 1, further comprising:
a loop antenna coupled to receive the amplified modulated RF signal and operable to resonate with an impedance greater than or equal to 50 ohms (Ω).

7. The FM transmitter of claim 6, wherein the loop antenna has an impedance greater than or equal to 2 kΩ.

8. The FM transmitter of claim 6, wherein the loop antenna has a Q greater than or equal to 30 in the FM frequency band.

9. The FM transmitter of claim 6, wherein the FM transmitter is operated at a power less than or equal to 2.5 milliamperes (mA).

10. The FM transmitter of claim 6, wherein the baseband processor is further operable to generate a tune control signal to tune the output of the power amplifier based on the power control signal.

11. The FM transmitter of claim 11, wherein the tune control signal tunes the power amplifier to produce an amplitude voltage of over 1 volt and a peak-to-peak voltage of over 2 volts.

12. The FM transmitter of claim 11, wherein the output of the power amplifier includes an array of tunable 8-bit switched capacitors and wherein the tune control signal operates to tune the 8-bit switched capacitors to drive the loop antenna with an inductance of at least 120 nanohenry.

13. The FM transmitter of claim 1, wherein the FM frequency band is between 65 MegaHertz (MHz) and 108 MHz.

14. The FM transmitter of claim 1, wherein the baseband processor generates the gain control signal during a calibration operation or a change channel operation.

15. A method for operating an FM transmitter, comprising:
producing a complex modulated digital signal;
converting the complex modulated digital signal to a complex modulated analog signal by a Digital-to-Analog converter (DAC);
filtering the complex modulated analog signal to produce a filtered complex modulated analog signal by a low pass filter;
up-converting the filtered complex modulated analog signal to a modulated RF signal;
amplifying the modulated RF signal and operable to produce an amplified modulated RF signal by a power amplifier;
measuring the output power of the modulated RF signal;
generating a power control signal indicative of the output power of the modulated RF signal; and
generating a gain control signal based on the power control signal to control a respective gain of the DAC, low pass filter and power amplifier to maintain a substantially constant transmit voltage over an FM frequency band.

16. The method of claim 15, further comprising:
providing the amplified modulated RF signal to a loop antenna having an impedance greater than or equal to 2 kΩ and a Q greater than or equal to 30 in the FM frequency band.

17. The method of claim 16, further comprising:
operating the FM transmitter at a power less than or equal to 2.5 milliamperes (mA).

18. The method of claim 16, further comprising:
generating a tune control signal to tune the output of the power amplifier based on the power control signal.

19. The method of claim 18, wherein the generating the tune control signal further includes:
tuning an array of 8-bit switched capacitors at the output of the power amplifier using the tune control signal to drive the loop antenna with an inductance of at least 120 nanohenry.

20. The method of claim 18, wherein the generating the tune control signal further includes:
tuning the power amplifier to produce an amplitude voltage of over 1 volt and a peak-to-peak voltage of over 2 volts.
